(19) United States
(12) Patent Application Publication
(10) Pub. No.: US 2017/0124827 A1
(43) Pub. Date: May 4, 2017

(54) Identifying an Association between a User of a Mobile Device and an Item of Merchandise

(71) Applicant: Aprium Tech Limited, London (GB)

(72) Inventors: Anthony Richard Hardie-Bick, London (GB); David Lee Sandbach, Brighton (GB)

(21) Appl. No.: 15/338,493

(22) Filed: Oct. 31, 2016

(30) Foreign Application Priority Data
Oct. 31, 2015 (GB) 1519373.3

(51) Int. Cl. G08B 13/24

(52) U.S. Cl. CPC G08B 13/246

(57) ABSTRACT

An association between a user of a mobile device (301) and an item of merchandise (501) is shown, in which each item of merchandise as a tag (601) attached thereto. The movement of tags is monitored to produce movement data (801). Proximity data is generated for each mobile device identifying tags that are in close proximity (802). The movement data is processed in combination with the proximity data to identify an association between a user and a mobile device and an item of merchandise to which an associated tag has been attached (803).

### CROSS REFERENCE TO RELATED APPLICATIONS

This application claims priority from United Kingdom patent application number GB 1519373.3, filed 31 Oct. 2015, the entire disclosure of which is incorporated by reference in its entirety.

### BACKGROUND OF THE INVENTION

The present invention relates to a method of identifying an association between a user of a mobile device and an item or merchandise, wherein each item of merchandise has a tag attached thereto. The present invention also relates to an apparatus for attachment to an item of merchandise. The present invention also relates to a server system configured to communicate with a fixed detector and a plurality of mobile devices in a retail environment.

It is known to apply security tags to items of merchandise in retail environments in order to deter and detect theft. Many devices of this type are passive and include components that are detected when a user passes interrogation apparatus, usually at an exit of a retail environment. Conventionally, tags of this type are difficult to remove and special equipment is required that is usually deployed by sales assistants at a check-out.

An alternative approach is to provide an active tag that continually generates a “keep alive” signal. In this way, it is possible for the movement of tags to be detected and this data may be considered, not only with respect to item security but also to assist with overall sales operations. Thus, the presence of tags in this environment starts to provide a positive benefit in addition to mitigating the negative problem of merchandise theft. Thus, it can be appreciated that the additional cost of tags of this type can be justified if there is an overall increase in sales.

However, known active systems only assist in terms of collecting data and a conventional sales process is still required in order for sales to be completed. Furthermore, it is also known for tags of this type to interact with mobile devices carried by users in order for information to be supplied, possibly via Bluetooth™ beacons, directing users to particular webpages. However, a problem with these known systems is that they still require a time-consuming sales operation to be performed, usually involving an interaction with a sales assistant.

### BRIEF SUMMARY OF THE INVENTION

According to an aspect of the present invention, there is provided a method of identifying an association between a user of a mobile device and an item of merchandise, in an environment where users of mobile devices browse items of merchandise, wherein each said item of merchandise has a tag attached thereto, comprising the steps of: monitoring the movement of said tags to produce movement data; identifying tags that are in close proximity to each said mobile device to generate mobile proximity data for the mobile device; and processing said movement data in combination with said proximity data to identify an association between a user of a mobile device and an item of merchandise to which an associated tag has been attached.

It is possible to make an association by effectively detecting that a mobile device belonging to a user and a tag attached to an item of merchandise are moving together; the user clearly holding the merchandise while they are moving. Thus, this requires the detection of two signals, one relating to the tag and the other relating to the mobile device.

In an embodiment, it is possible to detect the absolute movement of the mobile device within the retail environment and to detect the absolute movement of the tag within the retail environment. Thus, the movement data relates to this absolute movement of the tag and the proximity data relates to the absolute movement of the mobile device.

In an alternative embodiment, and as detailed herein by way of example only, it is possible to detect the absolute movement of the tags (providing the additional advantage of detecting theft) while detecting relative movement of the tag with respect to a mobile device. Thus, in this embodiment, the movement data relates to absolute movement of the tags and the proximity data relates to the relative closeness of the mobile device to one or more tags.

Thirdly, an alternative approach would be to detect the absolute movement of the mobile devices, providing the proximity data, while analysing the relative position of the tags with respect to the mobile devices, in order to generate the movement data. Thus, in this embodiment, the position of mobile devices will be detected and this detection process could be conducted by the mobile device itself. The mobile device itself would then be responsible for identifying tags that are in close proximity. Furthermore, in this third embodiment, the processing of the movement data in combination with the proximity data could be performed on a user's mobile device and the mobile device could then be used to complete a financial transaction.

In an embodiment, the tags may include passive transponders and movements may be detected when the transponders are interrogated. However, in a further embodiment, each said tag actively transmits an identifying signal; and said step of monitoring the movement of tags is performed by monitoring said actively-transmitted identifying signals. In addition, the monitoring of the identifying signals may comprise assessing signal strengths for said monitored signals.

Tag movement may be monitored by measuring the received signal strength indication (RSSI) of each tag and identifying significant and consistent changes in RSSI as indicative of a moving tag when the RSSI's of other tags are relatively constant. This relative movement may be obtained by measuring RSSI at more than one receiver. This may include other user mobile devices. Thus, the number of such receivers involved with such an assessment increases the accuracy with which such movements can be monitored, thereby increasing accuracy when more users are present. Thus, it would be possible for a significant degree of the processing to be done locally.

However, in an embodiment, signal strength data is received at a local server; received signal strengths are compared with previous signal strengths to produce movement data; and said movement data is uploaded to a remote server. Thus, it would be possible, for each user's mobile device to supply its tag RSSI data to a central server.

It is possible for mobile devices to determine location with reference to a number of tags using tag RSSI to obtain an estimate of tag proximity. In addition, it is possible for the mobile device to determine location with reference to a number of tags, by comparing its own location, obtained using GPRS/GSM base stations, Wi-Fi™ or other triangulation systems and/or pedestrian dead-reckoning using its internal accelerometer. Thus, this absolute location data derived from the mobile device could be used to obtain device movement, in which location varies with respect to time. The device movement data could then be compared with the tag movement data for each of the tags. The tag movement data provides an indication of changes of tag location, based on tag RSSI variations picked up by an in-store tag monitoring station.

It is then possible for the two types of movement data collected, comprising mobile device movement data and tag movement data, to be correlated, to obtain an indication of proximity of the mobile device to one or more tags. This proximity data may then be processed with movement data, from either the mobile device or a tag or a combination of both, to identify an association between a tag and a mobile device.

However, in an embodiment, the step of generating the mobile proximity data is performed by analysing identifying signals from the tags in close proximity to a mobile device.

Movement data and proximity data could be processed locally on a mobile device or on an in-store server. Furthermore, the inclusion of such server devices facilitates extending functionality to the supervision of payment requests etc.

In an embodiment, the identifying signal is an intermittent signal; intermittent signals from different tags are sent at different times; and each said intermittent signal includes tag identification data.

In an embodiment, the analysing step performed on a mobile device comprises the steps of: receiving identifying signals from tags in close proximity to the mobile device; identifying each unique tag from which identifying signals have been received; assessing the signal strength of each identified tag to produce said proximity data; and transmitting said proximity data.

In an embodiment, at a server: a first probability value for association is calculated with reference to said movement data; and a second probability of association is calculated with reference to said proximity data. The processing step to identify an association between a tag (attached to an item of merchandise) and a mobile device (in the possession of a user) may comprise the steps of: manipulating said first probability with said second probability to produce a combined probability; and comparing said combined probability with respect to a threshold.

To enhance security functionality, in an embodiment, the transmission of the identifying signal is disrupted if a tag is removed from an item of merchandise to which it is attached. This disruption may involve the total removal of the identifying signal or alternatively the disruption may involve making a modification to this identifying signal. Having detected an association, the removal may be authorised. However, if a removal is performed without authorisation, appropriate alerts may be generated.

According to a second aspect of the present invention, there is provided an apparatus for attachment to an item of merchandise, comprising: a tag mechanism for securing the apparatus to an item of merchandise; and an electronic circuit arranged to transmit an identifying signal, wherein the transmission of said identifying signal is configured to facilitate: the production of movement data by a detector in the environment; and the generation of proximity data by mobile devices in the environment.

In an embodiment, the identifying signal includes tag identification data and facilitates an assessment of signal strength.

According to a third aspect of the present invention, there is provided a server system configured to communicate with one or more fixed detectors and a plurality of mobile devices in a retail environment in which tagged merchandise is being offered for sale, wherein said server system includes: a data input device; a data storage device; a data processing device; and a data output device, wherein: said data input device receives movement data from said detectors derived from the movement of tags attached to said merchandise; said data input device receives proximity data from said mobile devices derived from the proximity of tags to said mobile devices; said processing device processes said movement data in combination with said proximity data to produce association data that associates tags with mobile devices; and said data output device supplies an output of said association data.

It is possible for the server system to be self-contained within a retail environment. However, in an embodiment, the server system comprises a local server located at the retail environment and a main server located remotely from said retail environment, wherein: said local server receives said movement data and said proximity data; said local server transmits changes in said movement data and transmits said proximity data to said remote server; said processing is performed at said remote server to produce said association data; and said association data is returned to said local server.

It is possible for transactional issues to be completed using this configuration. However, in an embodiment, a transactional server is included, configured to transact a merchandise purchase operation in response to receiving said association data.

In an embodiment, a conventional sale could take place after making an association. However, in an embodiment, association data for a particular user is notified to said user; and a transaction is completed in response to a recognised user action.

In an embodiment, the user action takes the form of a gesture performed by the user or could involve exiting through a particular doorway. Thus, arrangements could be made to the effect that a user facilitates associations being made, such that if a user then leaves the environment after the association has been made, it is assumed that a sale has been completed. However, in an embodiment, the user action comprises a step of tag removal, thereby confirming a positive action to the effect that a sale has been made and allowing the store to recycle tags. Alternatively, it would be possible for the tags to be provided with an appropriate mechanism that facilitates auto-release.

### BRIEF DESCRIPTION OF THE SEVERAL VIEWS OF THE DRAWING

FIG. 1 shows a server system communicating with detectors;

FIG. 2 details the main server identified in FIG. 1;

FIG. 3 illustrates a notification being received on a mobile device;

FIG. 4 illustrates interactions within a retail environment;

FIG. 5 illustrates the movement of merchandise within the environment of FIG. 4;

FIG. 6 illustrates an example of a tag attached to an item of merchandise;

FIG. 7 illustrates the release of the tag identified in FIG. 6;

FIG. 8 illustrates a method for obtaining association data;

FIG. 9 shows procedures implemented by a local server;

FIG. 10 illustrates a data structure created at each local server;

FIG. 11 shows procedures for generating mobile proximity data;

FIG. 12 shows a data structure of the type created on a mobile device;

FIG. 13 shows procedures performed by a main server;

FIG. 14 shows a proximity table and a movement table generated at the main server;

FIG. 15 shows an association table generated at the main server; and

FIG. 16 shows procedures for completing a transaction.

### DETAILED DESCRIPTION OF THE INVENTION

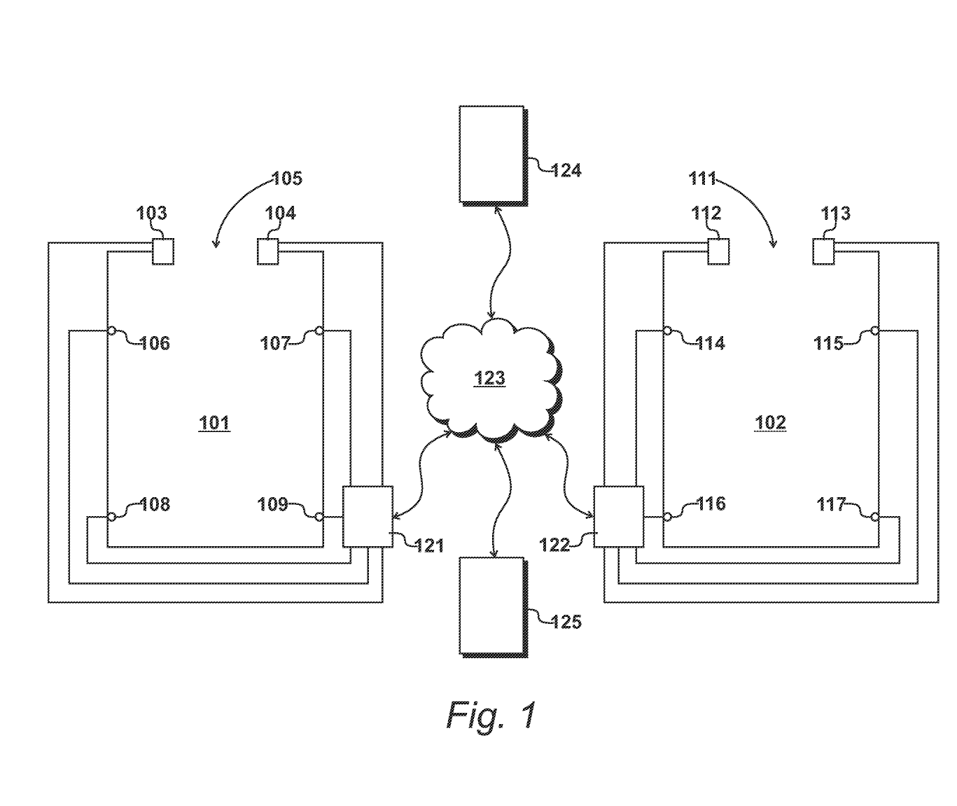

A server system is illustrated in FIG. 1, that is configured to communicate with fixed detectors and a plurality of mobile devices in retail environments. A first retail environment 101 is shown along with a second retail environment 102. In this example, a first detector 103 and a second detector 104 are provided at an entrance 105 to retail environment 101. Furthermore, within retail environment 101, there is provided a third detector 106, a fourth detector 107, a fifth detector 108 and a sixth detector 109. An embodiment may operate with a single detector but the system's ability to track the movement of merchandise is enhanced when the number of detectors present within the environment is increased.

A similar situation is provided at retail environment 102. Thus, at a second entrance 111 there is provided a seventh detector 112 and an eighth detector 113. Within the environment 102, a ninth detector 114 is included, along with a tenth detector 115, an eleventh detector 116 and a twelve detector 117.

Signals from detectors 113, 114 and 106 to 109, within retail environment 101, are supplied to a first local server 121. Similarly, signals from detectors 112 to 117, in the second retail environment 102, are provided to a local server 122. A communications network 123 provides communication between local servers 121, 122 and a main server 124. In addition, network 123 also provides communication with a financial transaction server 125.

In an embodiment, the detectors 113, 114 and 106 to 109 communicate signal data wirelessly to the first local server 121, and the detectors 112 to 117 communicate signal data wirelessly to the second local server 122.

In an embodiment, financial transaction server 125 allows web based sales to be made in accordance with standard procedures. Thus, a customer may view merchandise on a website and make a purchase using secure financial protocols. Thus, in an embodiment, part of this functionality is deployed to avoid duplication.

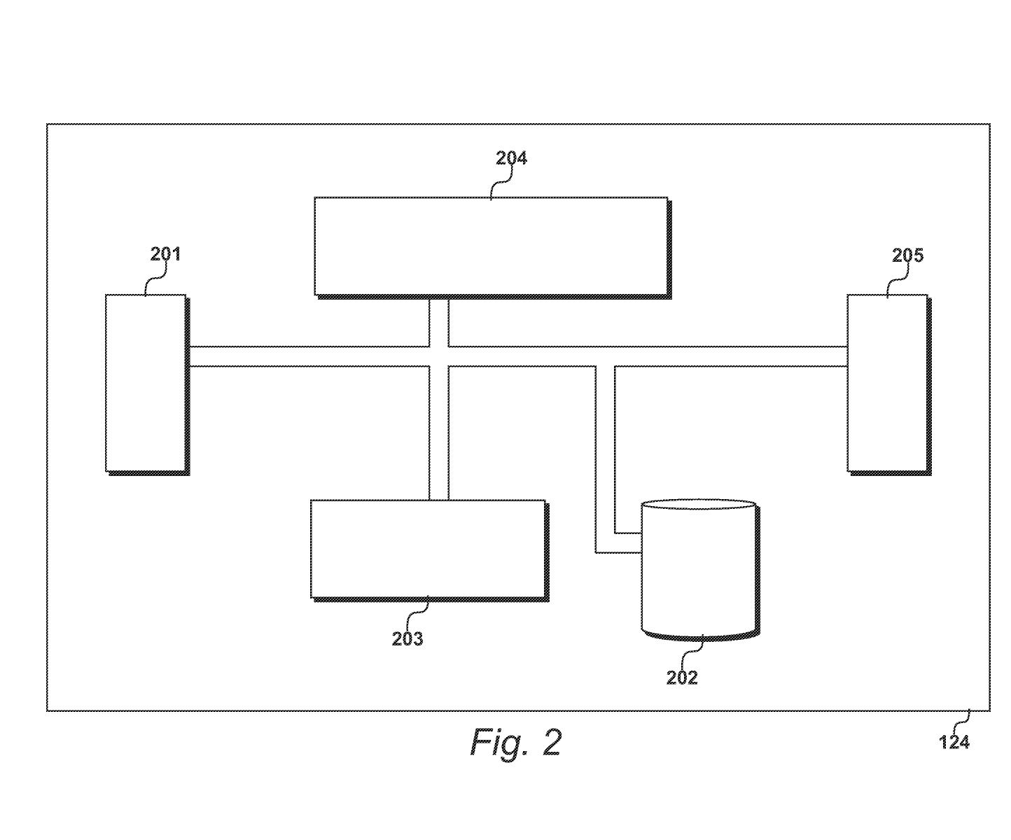

Main server 124 is detailed in FIG. 2. The server system includes a data input device 201, a data storage device 202, a processing unit 203, such as a quad-core CPU and a sixteen gigabyte random access memory subsystem 204. In an embodiment, the data storage device 202 is implemented as a non-volatile solid state drive. Furthermore, similar systems are provided at the local servers 121, 122 and the distribution of available processing power will be configured appropriately, depending upon the extent of processing done locally and extent of processing done remotely. In an embodiment, the remote server 124 may be implemented as a cloud based system.

Sensors, such as sensors 106 and 107 are implemented as Bluetooth transceivers connected to a power supply and connected to their respective local server (such as server 121) by physical Ethernet cables or by Wi-Fi. The purpose of the detectors is to pick up Bluetooth transmissions from tags attached to merchandise and they could be included in ceiling tiles for example, so as to be powered by a conventional lighting circuit.

The Bluetooth transceivers 106, 107 etc. may be implemented as Bluetooth low energy beacons and as such, they periodically send out a burst of data with a unique code. Conventionally, codes of this type are used to identify web addresses, thereby allowing customers to view further details of the merchandise by reading appropriate web pages. However, in the present embodiment, the data is specific to this particular deployment and in order for a user to benefit from the deployment, it is necessary for the user to run a specific application on their mobile device.

Within a retail environment, such as environment 101, an input device 201 receives movement data from detectors (106, 107 etc.) derived from the movement of tags attached to the merchandise. In addition, the input device 201 also receives proximity data from the mobile devices, derived from the proximity of tags to these mobile devices. A processing device is configured to process this movement data in combination with the proximity data to produce association data that associates tags with mobile devices. This association data results in the generation of output data from an output device 205. Thus, this output data is made available at the local server 121.

In an embodiment, the identification of association data is used to identify an intention, on the part of a user, to purchase a particular item of merchandise; thus in order to complete this, an interaction is made with the transactional server 125, configured to transact a merchandise purchasing operation in response to receiving the association data.

Thus, the transactional server is available for a customer to purchase, via a website, merchandise in a well-established manner. However, in addition, the present functionality allows a user to select an item of merchandise within a retail environment and thereafter, with minimal further intervention, conclude a retail purchase. This is achieved by detecting that a customer has picked up an item of merchandise and is moving within the retail environment holding the merchandise. To achieve this, an assessment is made to the effect that a tag, attached to an item of merchandise, is moving with a detected mobile device held by the customer. Thus, in an implementation, movement of the tag is detected, movement of the mobile device is detected and a correlation is made between the two; thereby providing strong evidence to the effect that an association exists and that the processing system may therefore make an assumption that a customer wishes to purchase a particular item of merchandise, without any further intervention on the part of any sales assistant.

In an embodiment, the association data for a particular user may be notified to the user and a transaction may be completed in response to a recognised user action. Thus, a user may be notified, via their mobile device, to the effect that the association has been identified and the user is then invited to confirm the purchase. However, in an embodiment, this interaction with a mobile device is not necessary. A user may confirm their intention to purchase the merchandise by merely walking out of the retail environment, facilitating detection by detectors 103 and 104 for example. Without this association being made and without an agreement being in place to the effect that a purchase may be concluded in this way, such an action would result in an alarm condition being raised. However, after making the association, the user is recognised as a customer and their account will be charged automatically without any further intervention.

In a further embodiment, at the retail entrance 105, the user is invited to physically remove the tag which will be recognised, after authorisation, as a confirmation to the effect that a customer wishes to purchase the merchandise.

Thus, using this active keep alive signal approach, it is not necessary to include physical devices for restraining the removal of the tag. If an association has been achieved, the tag may be removed without generating any alarm conditions. However, if a similar action is made by someone who has not been detected and associated with the merchandise, an alarm condition may be raised in accordance with known techniques.

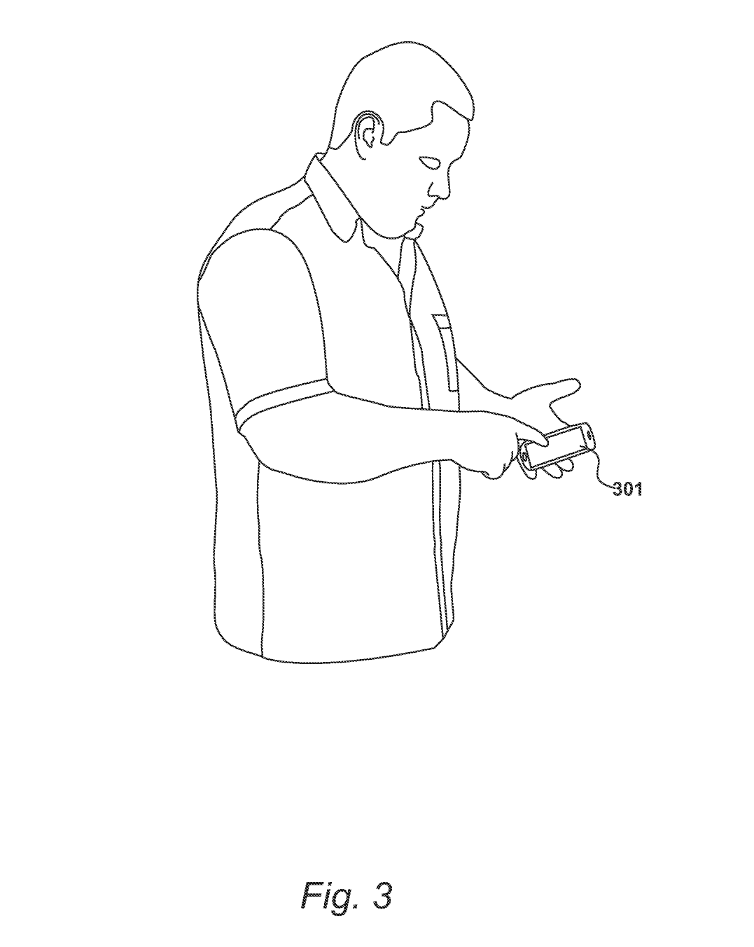

As illustrated in FIG. 3 upon entering retail environment 101 (or environment 102) a user receives a notification via their mobile device, such as a mobile cellular smartphone 301. To operate within the environment, the mobile phone 301 must be receptive to Bluetooth signals and the specific application (phone App) must be running. Upon activating the application, the user is identified by local server 121 and, in an embodiment, effectively logs on to the main server 124. The main server is now aware that this particular customer is browsing within retail environment 101.

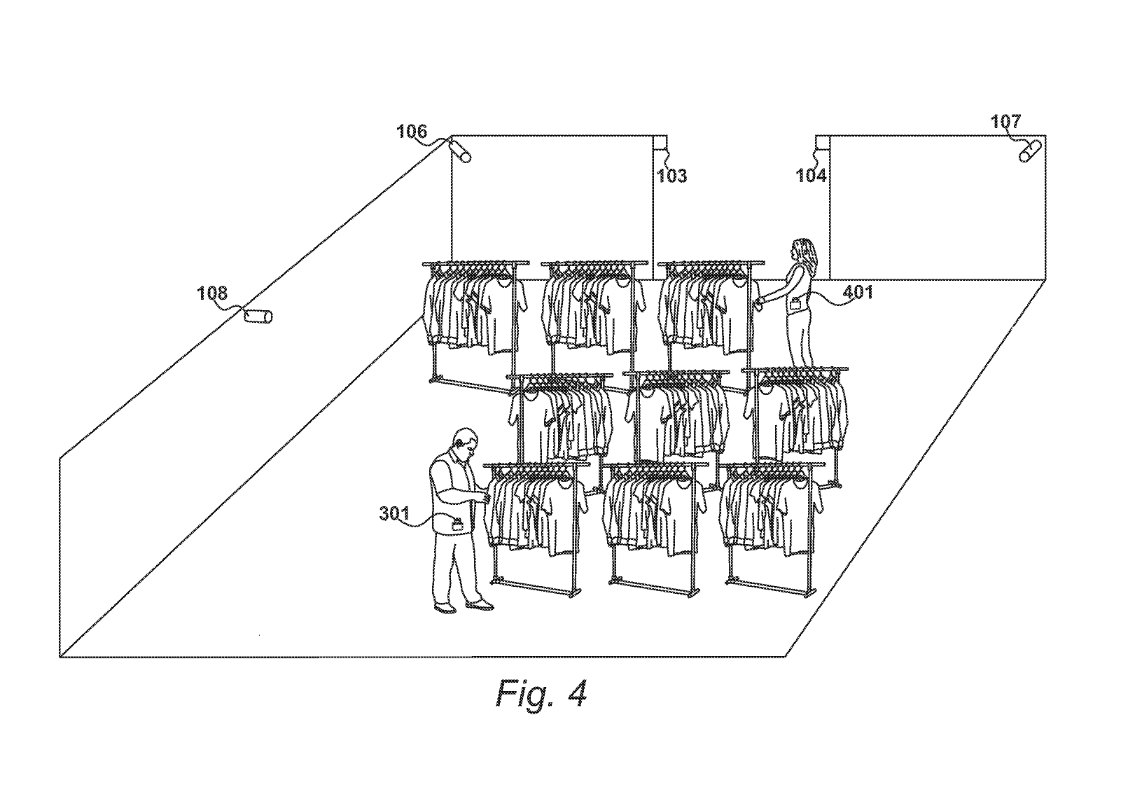

Within the retail environment, as illustrated in FIG. 4, a customer is invited to select merchandise and, for clothing, possibly try items on in appropriate changing areas. When engaged in this activity, it is not necessary for the user to interact with their mobile device and the device 301 may be retained in a pocket, provided that it is not shielded and Bluetooth connectivity is maintained. Furthermore, it should also be appreciated that within the environment, many other users may have a similar device, such as device 401.

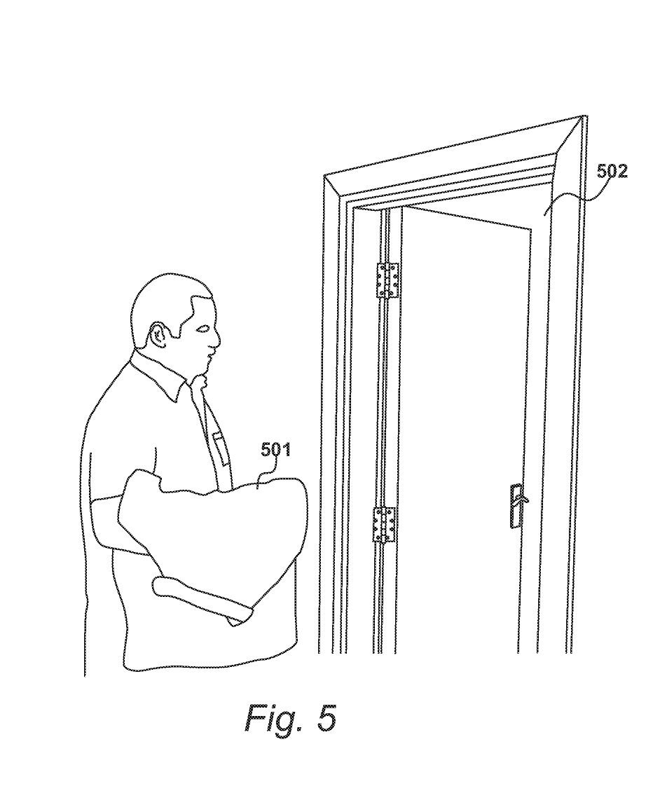

For the purposes of illustration, as shown in FIG. 5, it is assumed that a user has selected an item 501 and wishes to try the item on for size etc. The customer removes a selected item from a display rack and moves towards a changing room 502, as illustrated in FIG. 5. Consequently, in order to achieve this, it is necessary for the user, holding the item of merchandise 501 with a tag attached thereto, to travel a significant distance within the retail environment 101. As a user moves in this environment, in an embodiment, the mobile device 301 detects Bluetooth signals transmitted by many tags. These signals will increase in signal strength as the user approaches and this signal strength will then decrease as the user moves away. However, a relatively constant signal strength will be maintained between the mobile device 301 and the tag to which the item of merchandise 501 being carried is attached. Thus, as the user moves into the changing room 502 as shown in FIG. 5, there will be a high correlation between the movement of the tag that has been detected and the movement of the mobile device that has been detected.

Movement for the mobile device may be detected in an absolute sense, in the same way as tag movement is detected, or by other means. However, in an embodiment, tag movement is detected and the lack of movement between the mobile device and the tag itself is also detected which, when occurring together, creates a high probability to the effect that an association has been created between the tag and the mobile device. Thus, the local server is made aware of this association and may then take measures to complete the transaction without the user being required to interact with a sales assistant or get involved with conventional transaction procedures.

After leaving the changing room 502, the mobile phone 301 may receive a message inviting the user to confirm that they wish to purchase the item of merchandise. The merchandise could be taken to an identified transaction point, thereby confirming that the user does wish to purchase the merchandise. Given that the system is configured to detect movement, a particular gesture or movement could be completed on the part of the user, such as raising the merchandise above their head or waving it in a certain way. However, in an embodiment, the tag may be removed relatively easily. Normally, tag removal of this type would raise an alarm. However, in an embodiment, tag removal is allowed and encouraged after an association has been made.

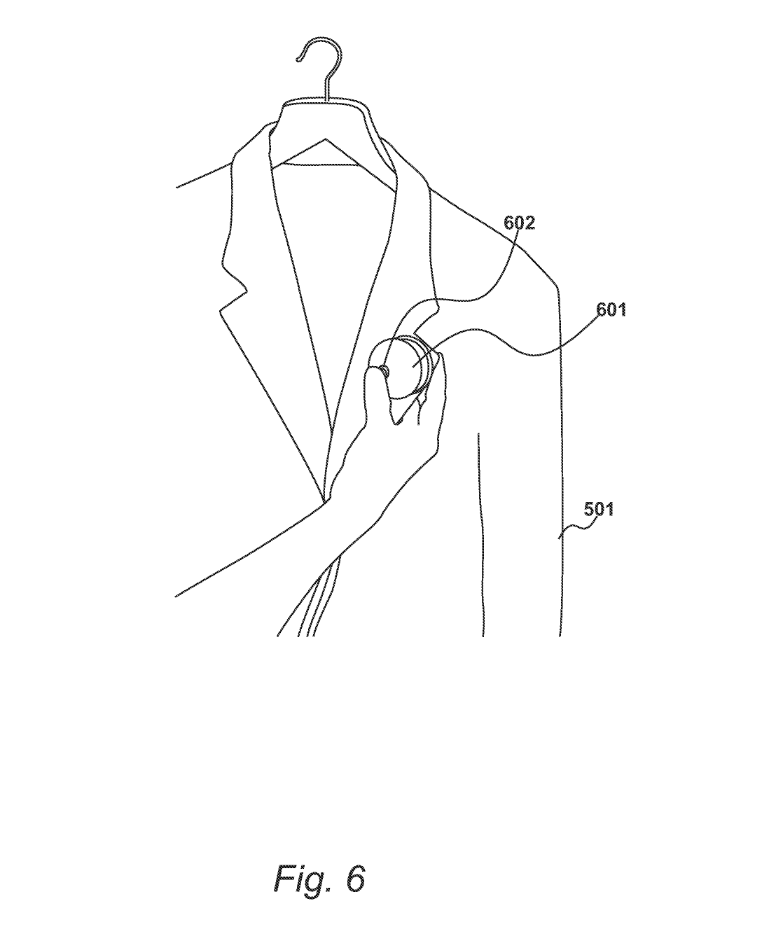

An example of a tag 601 is shown in FIG. 6, attached the item of merchandise 501. In this embodiment, tag release may be facilitated by applying manual pressure to a button 602. In further embodiments, the tag may include an illuminating device inviting a user to activate button 603. In response to the activation of button 603, a message may be sent back to the server system confirming that a sale is to be made. Alternatively, if button 603 is not activated within a predetermined period of time, it may be assumed that the customer does not wish to purchase the item of merchandise and the financial transaction is not initiated. In accordance with standard practice, the item could be left in the changing room 502 and later returned to the display by a sales assistant.

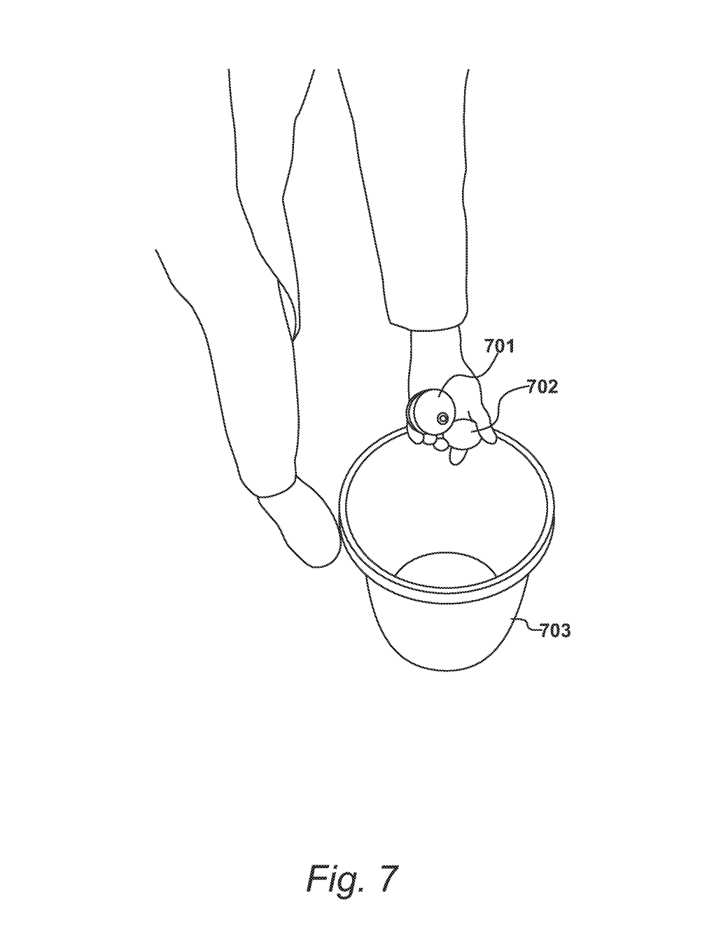

As illustrated in FIG. 7, upon activation of the release button 603, in an embodiment, the tag 601 becomes detached from the item of merchandise 501, such that it may be held as a first tag component 701 and a second tag 702. Users would then be encouraged to return these components to a recycling receptacle 703.

In an embodiment, Bluetooth tag 601 transmits a keep alive signal every two seconds. This signal is picked up by sensors (such as sensors 106 to 109) in retail environment 101 and while items remain stationary, signal levels will not change very much as measured by the received signal strength indication (RSSI). In addition, the continual reception of this signal also confirms that the item is still in the shop and has not been stolen.

When a customer picks up an item, as illustrated in FIG. 5, sensors will notice a change in signal strength. In addition, the keep alive signal will also be picked up by the application running on each mobile device. However, while walking through the retail environment, it is likely that the user's smartphone will detect many signals of this type.

When a user picks up an item and starts to move with it, possibly towards a changing room, the signal strength, as detected by the mobile phone retained by the user will remain relatively constant, but signal strength detected by detectors in the environment will start to change; increasing as a customer moves towards a detector and decreasing when they are moving away from it. Thus, the system is configured to determine whether a signal picked up by a shop sensor has changed. Furthermore, if a tag signal detected by the shop changes but the tag signal detected by the mobile device remains constant, there is a high likelihood that a user is moving with the article and this may be interpreted as creating an association between the user (via their mobile device) and the article of merchandise (via the tag secured thereto).

An association, in this embodiment, is interpreted as an intention on the part of a user to purchase the item. It is therefore possible to consider a probability to the effect that a purchase will take place. When this probability exceeds a predetermined threshold, an association signal may be generated. The probability is also likely to increase over time. Consequently, if the system detects that a user has been moving with a particular item of merchandise for more than a predetermined period of time, it may be assumed that a threshold has been exceeded and an association may be made to the effect that the user does wish to purchase the merchandise. The customer is then only required to perform a simple act, that is recognised as confirming the sale. Thus, the user is only required to move a distance that is sufficient for the item of merchandise to be noticed by the detectors as moving. Furthermore, the user has to retain the item for a sufficient period of time over which no movement is detected with respect to the tag and the mobile device supported by the user.

In an embodiment, detectors 106 to 109, for example, may communicate with a local server 121 by a process of meshing, in which signals may be transmitted between detectors before they are received at the local server 121. However, in the embodiment shown in FIG. 1, individual transmission paths are provided from each detector to the local server 121.

As previously described, similar hardware may be deployed for establishing each sub-server system. However, in an embodiment, it may be an objective to minimise the functionality of the local servers 121/122, thereby minimising the cost of installation; with the bulk of the processing being performed by a cloud based server 124. Thus, a specific functionality may be distributed, as considered appropriate, within the overall server system environment illustrated in FIG. 1.

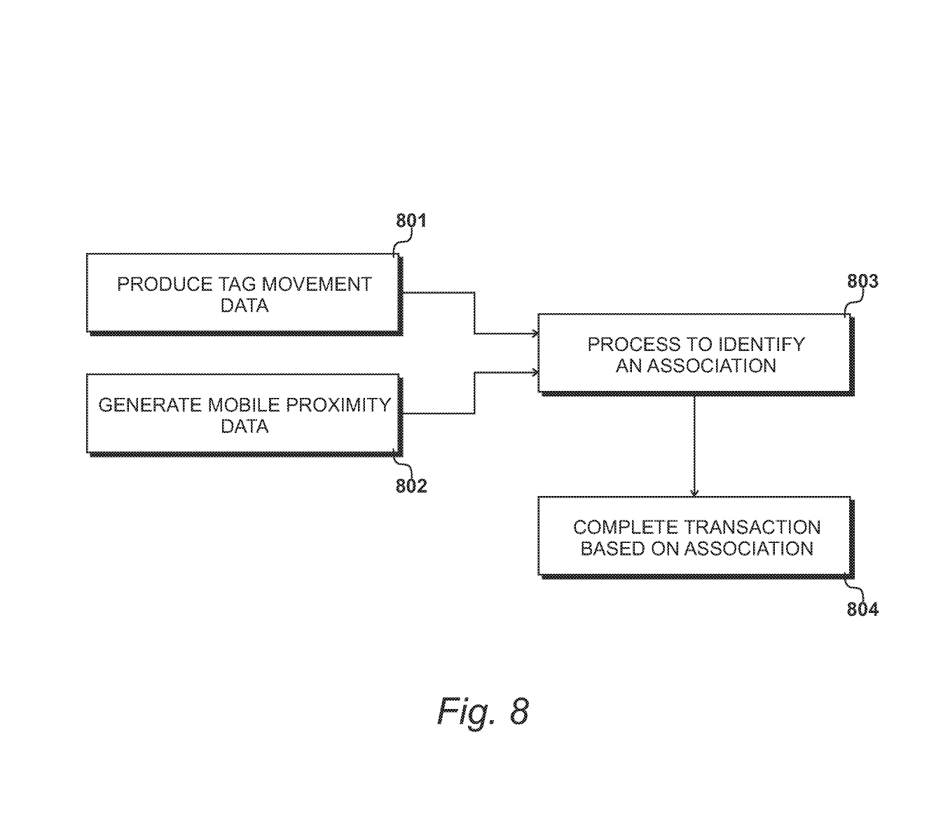

An embodiment is shown in FIG. 8, that provides a method of identifying an association between a user of a mobile device 301 and an item of merchandise 501. Each item of merchandise has a tag 601 attached thereto. The method monitors the movement of the tags to produce movement data at 801. In addition, mobile proximity data is generated at 802 for each mobile device, so as to identify tags that are in close proximity to the mobile device. This can be achieved by identifying the absolute location of the mobile devices (in a retail environment) and comparing this, over time, to the absolute location of the moving tags. In this way, it is then possible to correlate the movement of tags with the movement of mobile devices and an association can be established when a moving tag is identified as having a high correlation with the movement of a mobile device.

In an embodiment, absolute movement of tags is considered to produce the tag movement data but relative movement of tags, with respect to mobile devices, is considered to generate the proximity data. Thus, in this embodiment, it is possible to create an association by identifying tags that are moving with respect to fixed detectors in combination with tags that are not moving with respect to a specific mobile device. Thus, at 803 the movement data is processed in combination with the proximity data, to identify an association of a mobile device with an item of merchandise to which an associated tag has been attached.

In an embodiment, a tag is considered to be associated with the mobile device when the movement of the mobile device substantially corresponds to the movement of the tag. Given the pre-existing association between the tag and the item of merchandise, an association may then be made between the user of the mobile device and the tagged item.

Thereafter, at 804 it is possible for a transaction to be completed based on this association. For example, an association may be created if a user takes an item into a changing area. The user is then confronted with a choice; the item may be left in the changing area and no further action will be taken. Alternatively, the user may exit the store, possibly removing the tag, thereby confirming an intention to purchase the item, such that an appropriate financial transaction will take place. The removal of tags may be encouraged so as to allow the tags to be recycled. However, it is possible that tags will become smaller, require less power and become less expensive, therefore an alternative embodiment foresees the possibility of the tags becoming disposable after an item has been purchased.

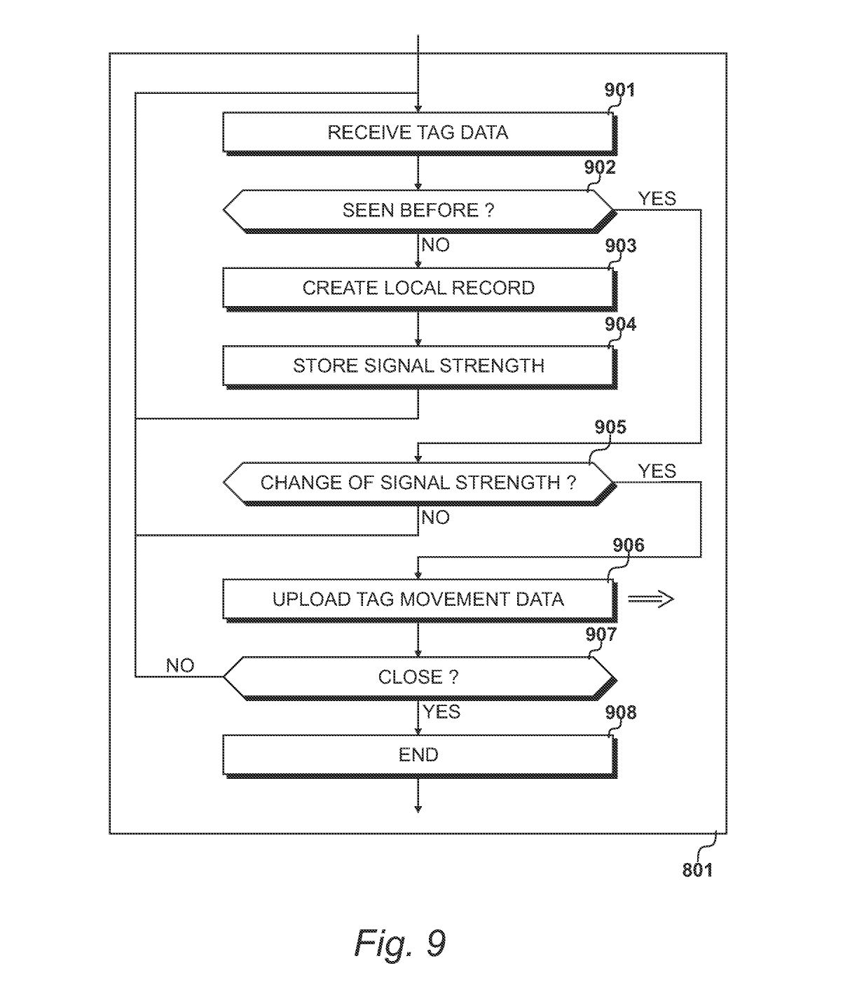

Procedures implemented by local server 121 in order to produce tag movement data, as indicated at 801, are detailed in FIG. 9. In this embodiment, each tag transmits an identifying signal and tag movement is performed by monitoring these identifying signals. Furthermore, in this embodiment, the monitoring of the identifying signals is performed by assessing signal strengths for the identifying signals. Indentifying signals may include signals generated by the active transmission of modulated radio frequency electromagnetic waves or some other kind of information-carrying wireless signal. In an embodiment, the identifying signals are Bluetooth Low Energy (BLE) signals that convey the presence of a nearby tag to another BLE-equipped device such as a mobile phone. Multiple tags are differentiated by modulating the wireless signal with a tag-specific code sequences, such as a BLE advertising packet containing a Universal Unique Identifier (UUID). As will be appreciated by those skilled in the art, the received signal strength indication (RSSI) of an identifying signal may be used to infer information about the proximity of the tag to a receiving device. Furthermore, the tag may include transmission strength data in its identifying signal, thereby enabling the proximity of the tag to be determined more accurately. In an embodiment, identifying signals may be provided from each individual tag, whereby power for the signals is derived from an incident energising field, such as ambient Wi-Fi signals. Alternatively, identifying signals may be imposed upon a reflected incident electromagnetic field by modifying the impedance of an energising antenna in the tag.

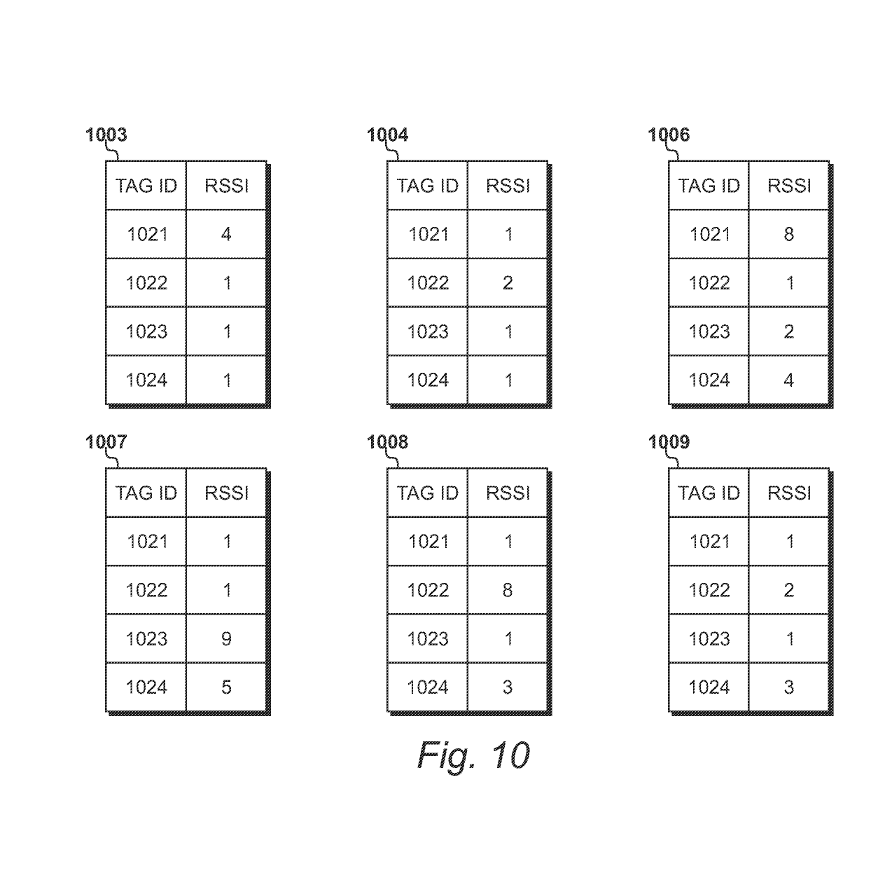

Signals are received at each of the detectors 103, 104, 106, 107, 108 and 109 and a local record is created for each of these detectors, as detailed in FIG. 10. Tag data is received at step 901, consisting of an indication of the originating detector, a unique tag identification and an indication of signal strength.

At step 902, a question is asked as to whether this tag has been identified before and when answered in the negative, a local record is created at step 903. Thereafter, at step 904 the received signal strength indication is stored in a respective table.

The next tag data is received again at step 901 and again a question is asked as to whether this tag has been seen before. If, on this occasion, the question is answered in the affirmative, reference is made to the relevant table and a question is asked at step 905 as to whether the signal strength has changed. Thus, given that the tag has been seen before, the local record will have recorded the previous signal strength. Thus, at step 905, it is possible for a comparison to be made between the previous signal strength and the new signal strength.

The resolution (or granularity) of the strength of the signal may be selected, such that a difference will be identified in signal strength if an item has actually moved; but minor changes, possibly due to changing reflection conditions due to the movement of people in the environment, will be quantised out. Thus, a change in signal strength should represent actual movement of a tag, either towards detector 108 (increasing signal strength) or away from detector 108, decreasing signal strength. For the purposes of this example, it is assumed that signal strength has been quantised over a range from zero to ten.

If the question asked at step 905 is answered in the affirmative, to the effect that there has been a change in signal strength, tag movement data is uploaded at step 906 to the main server 124. The tag movement data may consist of an identification of the tag (the tag id), an indication of the modulus of the change in signal strength and a representation of the time at which this difference was identified.

A question is asked at step 907 as to whether the procedure is to close and when answered in the negative, further tag data is received at step 901. Alternatively, the process ends at step 908.

Thus, in this embodiment, movement data is produced if a single instance is identified in a change of signal strength, resulting in movement data being supplied to the main server. It will be appreciated that alternative processing and/or filtering could be performed at local server 121 and sensitivity may be adjusted in order to optimise the production of tag movement data in response to an actual movement of a tag attached to an item of merchandise.

For each of the detectors 103, 104, 106, 107, 108 and 109 within a retail environment 101, each supplying signals to local server 121, a respective table 1003, 1004, 1006, 1007, 1008 and 1009 is created by the local server 121, as shown in FIG. 10.

Each of these tables records data received from tags within the environment. For the purposes of this example, tag ID's 1021, 1022 and 1023 have been detected by all of the detectors in the environment. For the purposes of this illustration, it is assumed that tag 1021 is close to detector 106, which records an RSSI of eight. Tag 1022 is close to detector 108, and again this records an RSSI of eight. Tag 1023 is assumed to be close to detector 107 and records an RSSI of nine. These signals are also received by the other detectors but their values are relatively low. For the purpose of illustration, a fourth tag ID 1024 is identified, with modest signal strengths being detected by all of the detectors in the environment.

On the next iteration of the procedures shown in FIG. 9, further tag data is received. In this embodiment, each tag produces a signal at approximately two second intervals. In the next interval, signals are generated again by tags 1021, 1022, 1023 and 1024.

Tag 1021 has been moved away from the left wall shown in FIG. 4, therefore detector 106 receives a signal strength of six, where previously it was eight. The question asked at step 902 will be answered in the affirmative, to the effect that the tag has been seen before and the question asked at step 905 will also be answered in the affirmative, to the effect that a change of signal strength has been detected. The change has a modulus of two units, therefore this value is uploaded to the main server 124 at step 906.

Again, for the purposes of illustration, tag 1022 moves away from detector 108 therefore on the next iteration, the signal strength of eight for this detector reduces to five and again the modulus of the difference (a value of three) will be uploaded at step 906.

Again, for the purposes of illustration, it is assumed that tag 1023 moves towards detectors 103 and 104. Thus, the value at detector 1003 will increase from one to seven (for example) and again the modulus of this difference (a value of six) will be uploaded at step 906.

Again, for the purposes of illustration, it is assumed that tag 1024 does not move, therefore on the next iteration all of the signal strengths will remain the same and the question asked at step 905 will be answered in the negative.

Thus, in this embodiment, it can be seen that the total volume of data transmitted to the main server 124 is relatively small, compared to the total data received by the local server 121. In this example, in addition to providing an indication that a movement has occurred, the modulus of the difference of the signal strength is also transmitted, thereby giving an indication of the extent of the movement. All of these movements provide an indication to the effect that an association between a user and an item of merchandise may be developing. There is a greater probability that someone may be looking to purchase the items that are moving, compared to the items that are not moving. However, to produce the association data, it is necessary to process this movement data in combination with the proximity data.

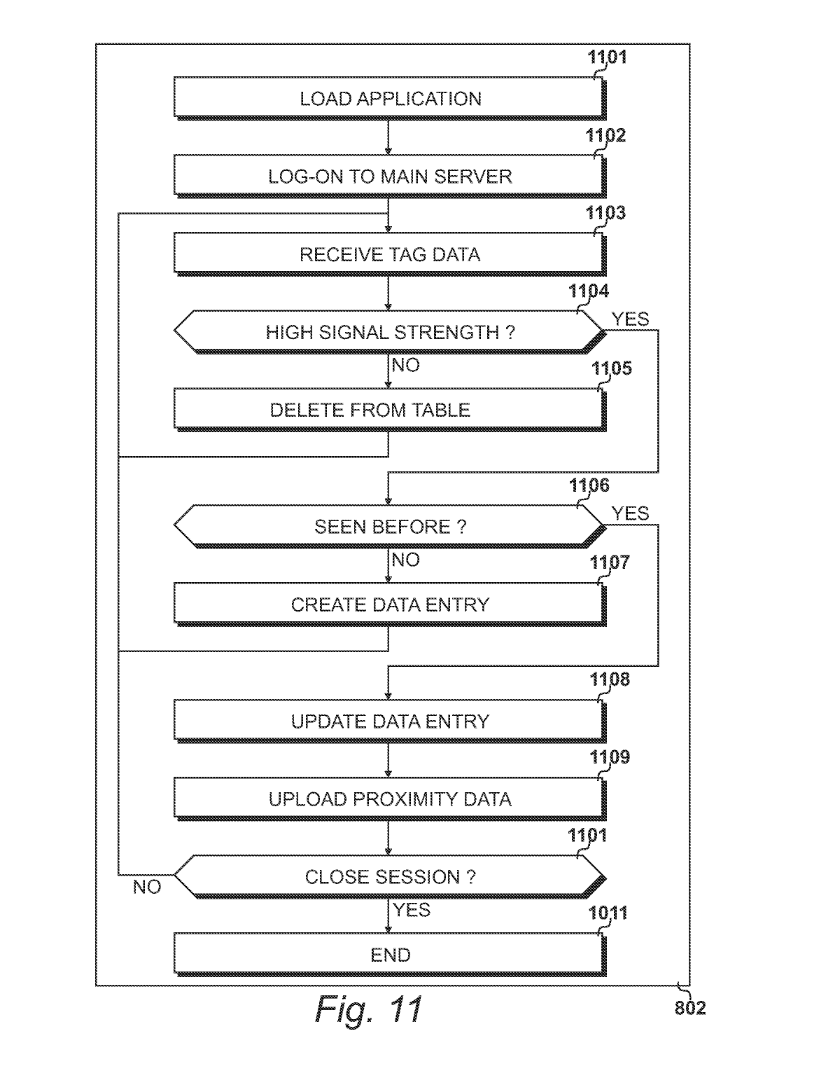

Procedures at 802 for generating mobile proximity data are illustrated in FIG. 11; as executed upon a user's mobile device, such as mobile smartphone 301.

At step 1101, a user loads the appropriate application (App) as illustrated in FIG. 3. Upon running the application, the smartphone 301 logs on to the main server 124, as indicated at 1002.

As a user considers articles of merchandise within the retail environment, as illustrated in FIG. 4, signals are received from many of the tags and the strength of these signals will vary as a user approaches a tag then moves away.

At step 1003 tag data is received which, as previously described, consists of identification data for the tag (a tag id) and an indication of signal strength.

At step 1004 a question is asked as to whether the signal strength is relatively high. Thus, for the generation of mobile proximity data, a thresholding exercise is performed by the mobile device, such that only tags that are relatively near are considered and distant tags (having a relatively low signal strength) are dismissed. Thus, signal strength may again be quantised over a range of values from zero to ten. Any signal having a strength value higher than, say, seven may be identified as being in close proximity.

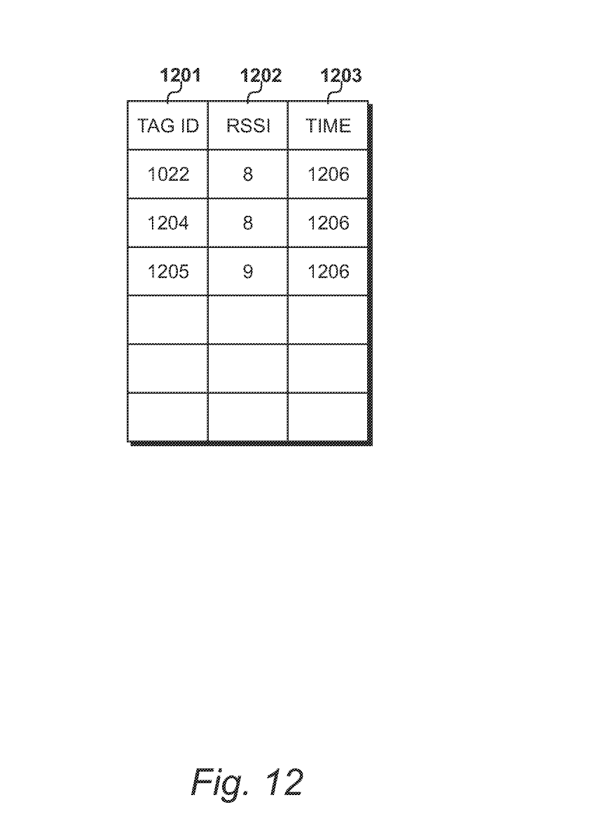

Furthermore, it is possible that a detected tag will have been detected before and on the previous detection, the tag could have had a high (eight, nine or ten) signal strength. This will have resulted in an entry being written to a table, as described with respect to FIG. 12, on the basis that the tag could have been a candidate. However, the customer has now moved away from that particular tag, therefore the tag is no longer a candidate for association. Thus, the entry is deleted at step 1005, if the signal strength has dropped to seven or below.

If the question asked at step 1004 is answered in the affirmative, to the effect that a high signal strength has been detected, a question is asked at step 1006 as to whether this tag has been seen before. If this question is answered in the negative, a data entry is created at step 1007. Thus, it can be appreciated that this data entry is of the type that, if signal strength diminishes, will be deleted at step 1005.

If the question asked at step 1006 is answered in the affirmative, to the effect that the tag has been seen before, the data entry is updated at step 1008. In this embodiment, if a tag is seen having a high signal strength twice, mobile proximity data is generated which is uploaded at step 1009. A question is then asked as to whether the session is to close at step 1010 and when answered in the negative, further tag data is received at step 1003.

Thus, in this embodiment, the reception of two high strength signals in succession from the same tag is interpreted as the user being in proximity to a particular item of merchandise. In this embodiment, two consecutive signals of this type will be approximately two seconds apart. However, it should be appreciated that in alternative embodiments, it may be necessary for significantly more consecutive high signal strength detections to be made for a particular tag before this decision is made and thus before mobile proximity data is generated that is in turn uploaded to the main server 124.

A data structure is shown in FIG. 12, of the type created at a user's mobile device in response to the execution of the procedures identified in FIG. 11. In the table shown in FIG. 12, the tag identification is recorded in column 1201, the received signal strength indication of the respective tag ID is recorded at column 1202 and a time at which the data was received for the respective entry is recorded at column 1203.

In this example, the table of FIG. 12 may represent that generated by mobile device 301. Device 301 is in close proximity to tags 1022, 1204 and 1205, having recorded an RSSI of eight, eight and nine respectively. These values have been recorded at time 1206.

For the purposes of this example, it is assumed that on the next iteration, mobile device 301 continues to be in close proximity to tag 1022. This tag has been seen before, therefore the question asked at step 1106 will be answered in the affirmative. Again, for the purposes of this example, it is assumed that the RSSI value has increased from eight to ten and the value is therefore updated at step 1108. Furthermore, this proximity data is uploaded at step 1109.

For the purposes of this example, it is also assumed that mobile device 401, which will create its own table, is in close proximity to tag 1023. Thus, proximity data is also uploaded showing that mobile device 401 is in close proximity to tag 1023.

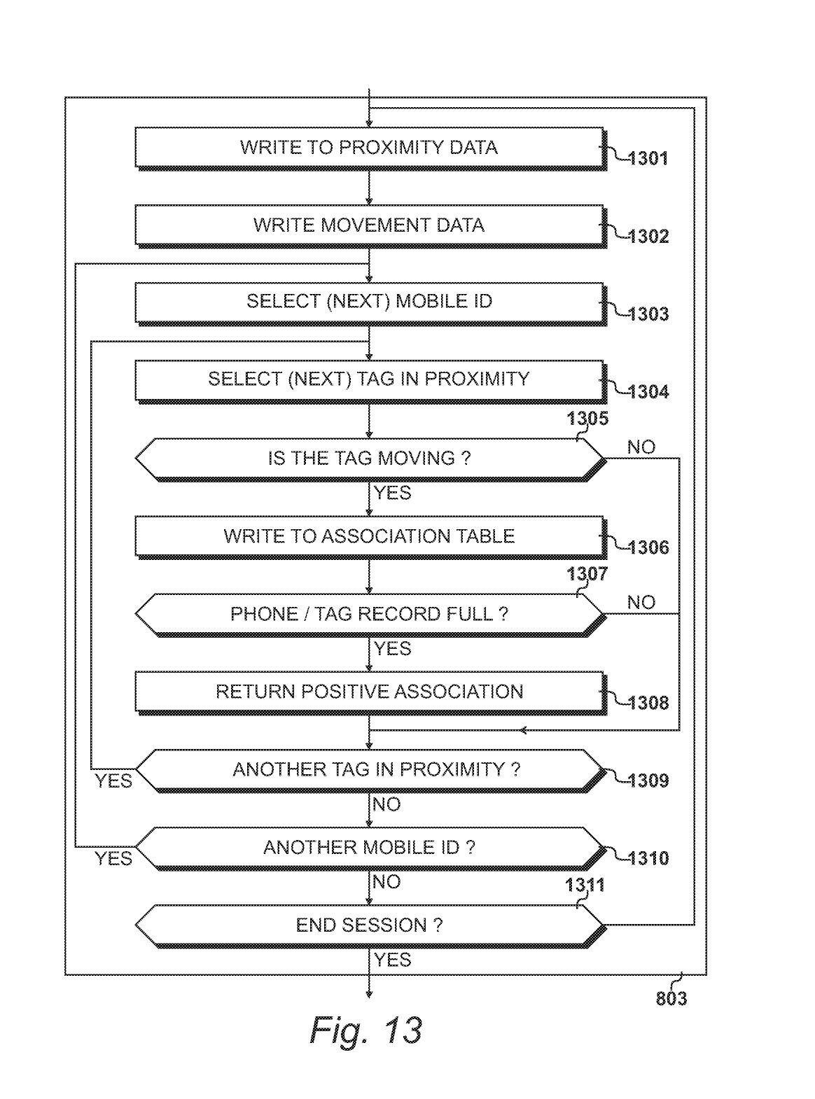

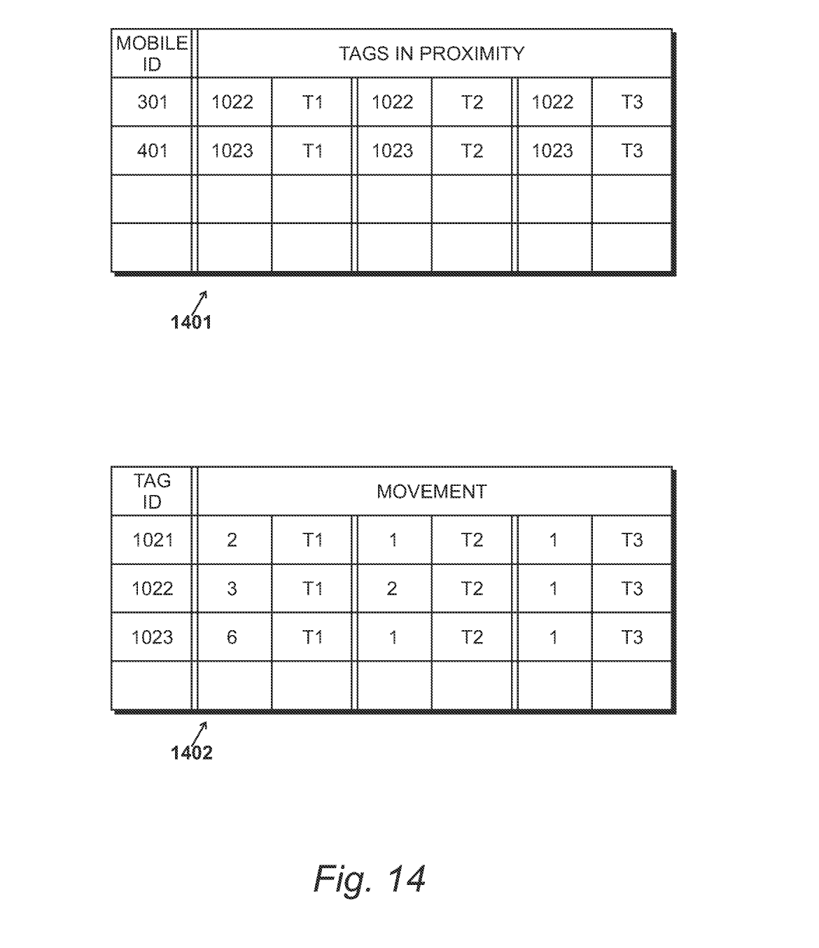

Procedures performed by the main server 124 are illustrated in FIG. 13. Tag movement data is uploaded to the main server in response to the operation of process 906. This proximity data is written to a data structure, as illustrated in FIG. 14, at step 1301. Similarly, proximity data is uploaded to the main server in response to the operation of process 1109 and this is written to a data structure, shown in FIG. 14, at step 1302.

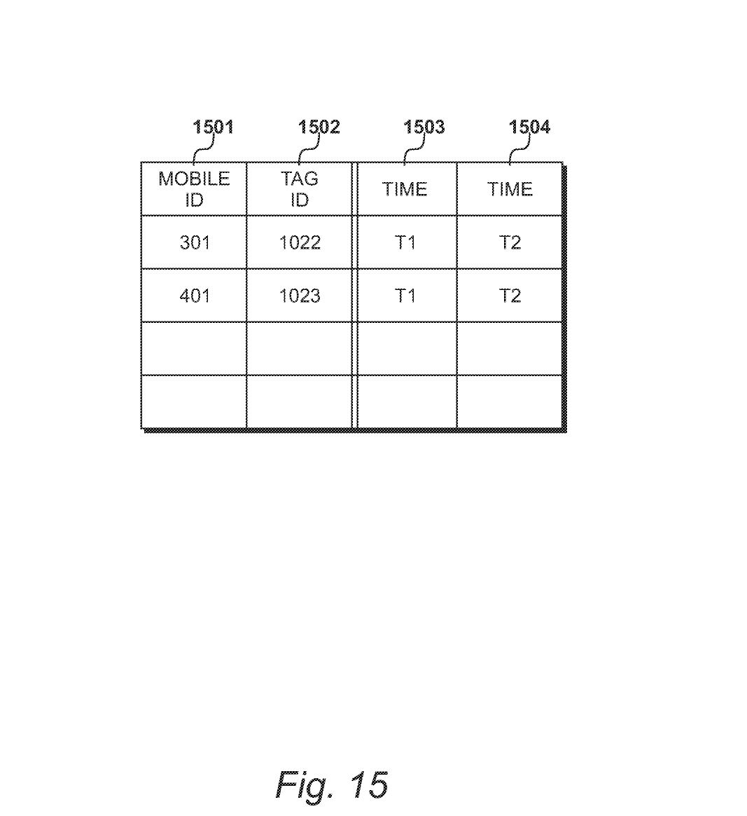

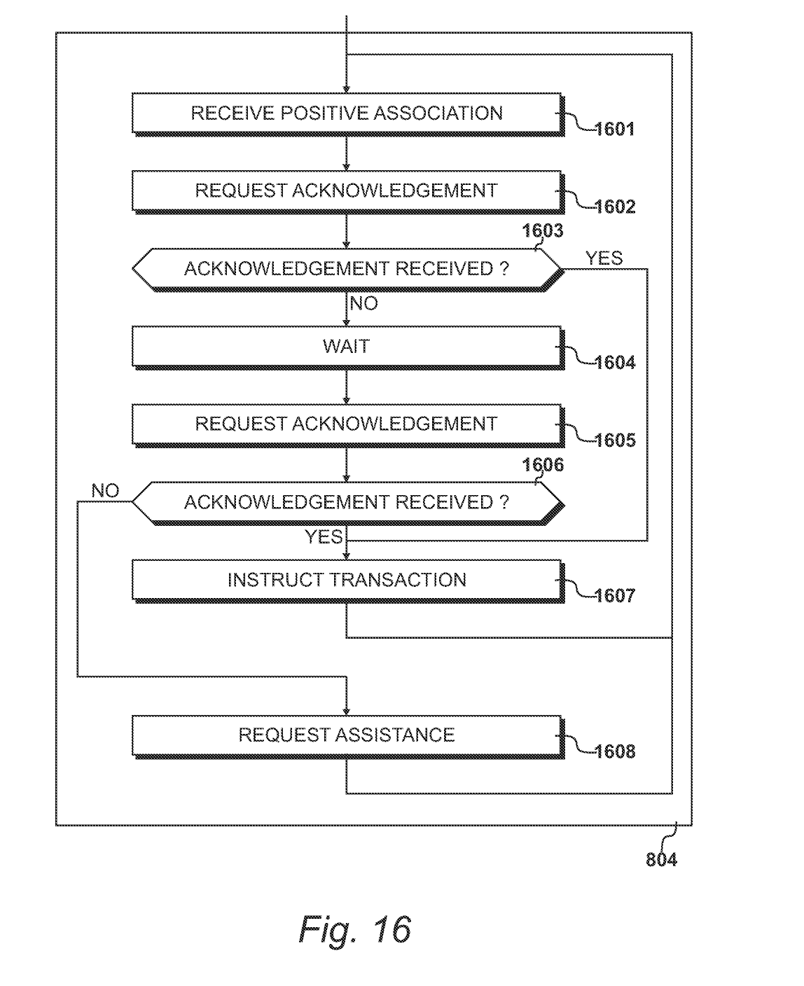

Candidates for association are written to a data structure as shown in FIG. 15. In this embodiment, candidates for association are identified when a tag is in close proximity to a mobile device and at the same time the tag is moving. This will occur predominantly when items are taken into changing rooms and when items are taken out of the retail environment. In this embodiment, the system looks to identify three consecutive associations of this type, which is then interpreted as providing strong evidence (i.e. providing a high probability) to the effect that an association exists, which is then put forward for completing a transaction, as detailed in FIG. 16.

From table 1401, identified in FIG. 14, a mobile device is selected at step 1303. For this mobile device, a first tag is selected that is in proximity with the mobile device at step 1304. Thereafter, at step 1305, a question is asked as to whether the tag is moving. If this question is answered in the affirmative, a potential association has been identified and this is written to an association table at step 1306.

At step 1307 the association table (shown in FIG. 15) is considered to determine whether the record is full. As illustrated in FIG. 15, in this example, the record is capable of storing two potential associations, such that it will be full when a third potential association is received. Thus in response to receiving this third potential association, a positive association indication is returned to the originating local server 121.

At step 1304, a question is asked as to whether another tag is in proximity. This question is also asked if the question asked at step 1305 is answered in the negative (to the effect that the tag is not moving) or the question asked at step 1307 is answered in the negative, to the effect that the phone/tag record is not full.

In response to the question asked at step 1309 being answered in the affirmative, the next tag in proximity is selected at step 1304 and again an assessment is made as to whether a positive association exists. Eventually, all of the tags in proximity to a particular mobile device will have been considered and the question asked at step 1309 will be answered in the negative. As a result of this, a question is asked at step 1310 as to whether another mobile identification is present. When answered in the affirmative, the first tag in proximity to this new mobile device is selected at step 1304 and the processes are repeated. Thus, eventually, all of the tags in proximity with all of the mobile devices will have been considered and the question asked at step 1310 will be answered in the negative. In response to this, a question is asked at step 1311 as to whether the session is to end and when answered in the negative, further data is written to tables at step 1301 and step 1302.

A proximity table 1401 is shown in FIG. 14, populated in response to the operation of process 1301. Similarly, a movement table 1402 is also shown in FIG. 14, populated in response to the operation of process 1302.

For the purposes of this example, the proximity table has identified mobile devices 301, 401 and 1403 as being in close proximity to tags within the environment. In the table, each entry identifies a specific tag, along with an indication of the time at which the detection of proximity occurred. Thus, for the record relating to mobile device 301, the device was in proximity to tag 1022 at times T1, T2 and T3. Similarly, mobile device 401 was in proximity to tag 1023 at times T1, T2 and T3.

Referring to table 1402, movement data has been written at step 1302 for tags 1021, 1022 and 1023. Movements have been detected at times T1, T2 and T3.

An example of an association table is illustrated in FIG. 15. This table is populated in response to the process shown in FIG. 13 operating on the data illustrated in FIG. 14.

The association table includes a first column 1501 for a phone identification, followed by a second column 1502 for a tag identification. Thus, each entry in this table relates to a specific phone with a specific tag. Thus, the same phone may occur several times with respect to different tags. Such a situation would arise if, for example, a user were to take several items of merchandise into a changing area. This is then followed by a first column 1503 identifying a time at which a candidate association has been identified, along with a second column 1504 identifying a second instance at which a candidate association has been made. If a third consecutive instance is identified, this is then treated as a positive association, the data is cleared in the table of FIG. 15 and positive association data is supplied to the local server 121.

At step 1303 a mobile ID is selected which, for the purposes of this example, would result in the selection of mobile ID 301. At step 1304 a tag in proximity is selected which in this example is tag 1022. This potential association occurred at time T1. Thus, referring to the movement table, it can be seen that tag 1021 was moving at time T1, therefore a potential association does exist and time T1 is recorded in the association table. On this iteration, the phone/tag record is not full, therefore the question asked at step 1307 is answered in the negative. There are no other tags in proximity (in this example) therefore the next mobile device is selected at step 1310. This is represented by device 401 and the tag selected at step 1304 is tag 1023. Again this is a first occurrence and there are no other tags to consider. All of the mobile devices have been considered therefore the question asked at step 1310 will be answered in the negative and the further writing of data will then occur at steps 1301 and 1302.

Thus, on the next iteration, column 1504 will be populated to the effect that mobile device 301 was in close proximity to tag 1022 and tag 1022 was moving at time T2. Similarly, tag 1023 is identified as being in close proximity as mobile device 401 at time T2.

On the third iteration, mobile device 301 will be selected along with tag 1022. Table 1402 confirms that the tag continues to move at time T3 and an attempt to write this to the association table of FIG. 15 is not possible because the record is full. Thus, the question asked at step 1307 will be answered in the affirmative and the positive association will be returned at step 1308.

A similar situation arises for the association between mobile phone 401 and tag 1023. Thus, again, a positive association will be returned.

Procedures 804 for completing a transaction based on an association are detailed in FIG. 16. At step 1601 a positive association is received, in response to the generation of positive association data at step 1308. In an embodiment, nothing further is required in order to complete the transaction but in the embodiment described herein, an acknowledgement is required before a transaction may be completed. Thus, in an embodiment, a user may receive a notification on their mobile device asking whether they wish to purchase the item for which an association has been made. In response to this, a user may accept or decline the invitation.

In an alternative embodiment, the security tag may be released as shown in FIG. 6. Thus, at step 1603 a question is asked as to whether an acknowledgement has been received.

It is appreciated that in many instances a period of time may be required in order for a user to make a decision. Furthermore, it may be necessary for the user to reach a particular location within the environment before the decision can be acknowledged. Thus, a period of waiting is entered at step 1604.

After step 1604, a further request for an acknowledgment is made at step 1605. Again, a question is asked at step 1606 as to whether an acknowledgement has been received and if this question is answered in the affirmative, an instruction is generated to the transactional server 1205 to the effect that a transaction is to be completed.

Alternatively, if an acknowledgement is not received, assistance may be requested at step 1608. A user may, for example, have left merchandise in the changing area and the request for assistance at step 1608 may call an assistant to return the merchandise from this are to the main sales area. Furthermore, appropriate alarms may be raised if the item has been removed without the transaction being acknowledged.

The invention claimed is:

1. A method of identifying an association between a user of a mobile device and an item of merchandise, in an environment where users of mobile devices browse items of merchandise, wherein each said item of merchandise has a tag attached thereto, comprising the steps of:
monitoring the movement of said tags to produce movement data;
identifying tags that are in close proximity to each said mobile device to generate mobile proximity data for the mobile device; and
processing said movement data in combination with said proximity data to identify an association between a user of a mobile device and an item of merchandise to which an associated tag has been attached.

2. The method of claim 1, wherein:
each said tag transmits an identifying signal; and
said step of monitoring the movement of tags is performed by monitoring said identifying signals.

3. The method of claim 1, wherein the monitoring of the movement of said tags includes assessing signal strengths of their respective received identifying signals.

4. The method of claim 3, wherein:
signal strength data is received at a local server;
received signal strengths are compared with previously received signal strengths to produce movement data; and
said movement data is uploaded to a remote server.

5. The method of claim 1, wherein said step of identifying tags in close proximity is performed by analysing signal strengths of identifying signals from tags in close proximity.

6. The method of claim 1, wherein:
said tags transmit an intermittent signal;
intermittent signals from different tags are sent at different times; and
each said intermittent signal includes tag identification data.

7. The method of claim 1, wherein said step of identifying tags is performed on a mobile device and comprises steps of:
receiving identifying signals from tags in close proximity to the mobile device;
identifying each unique tag from which identifying signals have been received;
assessing the signal strength of each identified tag to produce said proximity data; and
transmitting said proximity data.

8. The method of claim 1, wherein at a server:
a first probability value for association is calculated with reference to said movement data; and
a second probability of association is calculated with reference to said proximity data.

9. The method of claim 8, wherein said processing step to identify an association between a tag (attached to an item of merchandise) and a mobile device (in the possession of a user) comprises the steps of:
manipulating said first probability with said second probability to produce a combined probability; and
comparing said combined probability with respect to a threshold.

10. The method of claim 1, wherein the transmission of said identifying signal is disrupted if a tag is removed from an item of merchandise to which it is attached.

11. An apparatus for attachment to an item of merchandise, comprising:
a tag mechanism for securing the apparatus to an item of merchandise; and
an electronic circuit arranged to transmit an identifying signal, wherein
the transmission of said identifying signal is configured to facilitate:
(a) the production of movement data by a detector in the environment; and
(b) the generation of proximity data by mobile devices in the environment.

12. The apparatus of claim 11, wherein said tag mechanism is configured to allow manual removal by a user without additional equipment.

13. The apparatus of claim 12, wherein said manual removal disrupts the identifying signal.

14. The apparatus of claim 11, wherein said identifying signal includes tag identification data and facilitates an assessment of signal strength.

15. The apparatus of claim 14, wherein said identifying signal is a Bluetooth signal.

16. A server system configured to communicate with one or more fixed detectors and a plurality of mobile devices in a retail environment in which tagged merchandise is being offered for sale, wherein said server system includes:
a data input device;
a data storage device;
a data processing device; and
a data output device, wherein:
said data input device receives movement data from said detectors derived from the movement of tags attached to said merchandise;
said data input device receives proximity data from said mobile devices derived from the proximity of tags to said mobile devices;
said processing device processes said movement data in combination with said proximity data to produce association data that associates tags with mobile devices; and
said data output device supplies an output of said association data.

17. The server system of claim 16, comprising
a local server located at said retail environment and
a main server located remotely from said retail environment, wherein:
said local server receives said movement data and said proximity data;
said local server transmits changes in said movement data and transmits said proximity data to said remote server;
said processing is performed at said remote server to produce said association data; and
said association data is returned to said local server.

18. The server system of claim 16, including a transactional server configured to transact a merchandise purchasing operation in response to receiving said association data.

19. The server system of claim 18, wherein:
association data for a particular user is notified to said user; and
a transaction is completed in response to a recognised user action.

20. The server system of claim 19, wherein said user action comprises a removal of an associated tag by said user.
